(19) United States
(12) Patent Application Publication
(10) Pub. No.: US 2006/0197398 A1
(43) Pub. Date: Sep. 7, 2006

(54) Composite winding

(75) Inventor: Rafael O. Maynez, El Paso, TX (US)

Correspondence Address: YOUNG & BASILE, P.C., 3001 WEST BIG BEAVER ROAD, SUITE 624, TROY, MI, 48084, US

(73) Assignee: Valeo Electrical Systems, Inc., Auburn Hills, MI (US)

(21) Appl. No.: 11/073,803

(22) Filed: Mar. 7, 2005

(51) Int. Cl. H02K 3/14

(52) U.S. Cl. 310/198; 310/208

(57) ABSTRACT

An energy conversion machine and a method of manufacturing an energy conversion machine comprising a composite winding. The composite winding comprises two separate windings having two different wire gauges. One winding is primarily selected to obtain a desired stall torque or a desired short circuit current, while the other winding is primarily selected to obtain a desired no-load speed or open circuit voltage. A machine incorporating a composite winding can be smaller and lower cost than a conventional machine designed to the same parameters.

### FIELD OF THE INVENTION

The invention relates to a method to circumvent slot-fill limitations in the design of DC energy conversion machines such as motors and generators through the use of composite windings and to machines including composite windings.

### BACKGROUND

The performance of a motor or generator is determined by its winding. Wire gauges and the number of turns are the variables that define a winding. The speed and strength of a motor are controlled through the selection of wire gauge and number of turns. In a generator, the voltage and current output are controlled through the selection of wire gauge and number of turns.

There are almost no limits for how thick a wire can be wound in such energy conversion machines. As the diameter of a wire wound on the armature increases, the first constraint becomes the manufacturing equipment. A winding machine can only handle wire in a certain size range. However, new fixtures can usually shift the range to larger dimensions. The next limit is the width of the slot opening. The specified wire may be so large that it does not fit between the poles. To get around this constraint, instead of winding one bobbin with thick wire, two or more bobbins may be made with thinner wire. For example, instead of winding an armature with one wire with 0.5 mm² in cross-sectional area, one can use two wires with a 0.25 mm² cross-sectional area and obtain the same performance. Because of the availability of fixture re-designs and the use of multiple windings, there are no practical limits to how large a wire may be used in these machines.

When it comes to the number of turns in a winding, there are no techniques to circumvent limitations. Every turn of wire takes up space in the armature slot that is at least equal to the cross-sectional area of the wire. As the number of turns increases, the slot becomes fuller. At some point, the area of the slot cannot accommodate the wire bundle. Specifically, the slot is full, and no more turns can be added. The only design option is to shift to a package of larger diameter and/or length.

### SUMMARY

The invention discloses a method and a energy conversion machine that circumvents these slot limitations. A first aspect of the invention is a machine comprising an annular stator and a rotatable rotor facing a surface of the stator, the rotor including a plurality of rotor slots. The machine also includes a first winding in at least one of the plurality of rotor slots, the first winding having a first cross-sectional area and a first number of turns, and a second winding in the at least one of the plurality of rotor slots, the second winding having a second cross-sectional area different from the first cross-sectional area and having a second number of turns.

A second aspect of the invention is a method of manufacturing a machine including a stator and a rotor wherein the rotor includes rotor slots. The method including the steps of installing a first winding in at least one of the rotor slots, the first winding having a first cross-sectional area and a first number of turns, and installing a second winding in the at least one of the rotor slots, the second winding having a second cross-sectional area different from the first cross-sectional area and having a second number of turns.

Additional aspects and features of the inventive machine and method are described hereinafter.

### BRIEF DESCRIPTION OF THE DRAWING

The various features, advantages, and other uses of the present invention will become more apparent by referring to the following detailed description and drawing in which:

FIG. 1 is a partial plan view of a machine armature with 8 turns of wire gauge A;

FIG. 2 is a graph showing an idealized performance curve of the machine of FIG. 1 operating as a motor and a desired shift in the performance curve for an application requiring slower speed and higher force;

FIG. 3 is a partial plan view of the armature of FIG. 1 with 15 turns of wire gauge B;

FIG. 4 is a partial plan view of the armature of FIG. 3 with a composite winding according to the present invention;

FIG. 5 is a graph illustrating the performance of a direct-drive motor including a speed winding;

FIG. 6 is a graph illustrating the performance of a direct-drive motor including a torque winding;

FIG. 7 is a graph illustrating the performance of a direct-drive motor including a composite winding in accordance with the present invention; and

FIG. 8 is a graph comparing the idealized torque-speed curves for each of a speed winding, a torque winding and a composite winding.

### DETAILED DESCRIPTION

In traditional energy conversion machine designs, the slot-fill limit in windings is encountered when trying to increase motor strength and/or reduce speed in the case of a motor or when trying to increase current and/or reduce voltage in the case of a generator. Larger diameter wire is necessary to increase the stall torque, making a motor stronger, or to increase the short circuit current rating of a generator.

This larger diameter wire, of course, takes up more area inside the slot. Similarly, to reduce motor no-speed or to reduce the open-circuit voltage rating of a generator, winding turns must be added to the armature. Every winding turn reduces the available slot area. An example best illustrates this problem. Assume the existence of a motor 10 wound with eight (8) turns of magnet wire of gauge A as partially illustrated in FIG. 1. The wire is wound on the teeth of a rotor 12 with a slot opening facing the stator 14. Of course, the invention would also work with machines where the rotor rotates around, instead of inside, the stator. For simplicity, no stator will be shown in the remainder of the drawing figures.

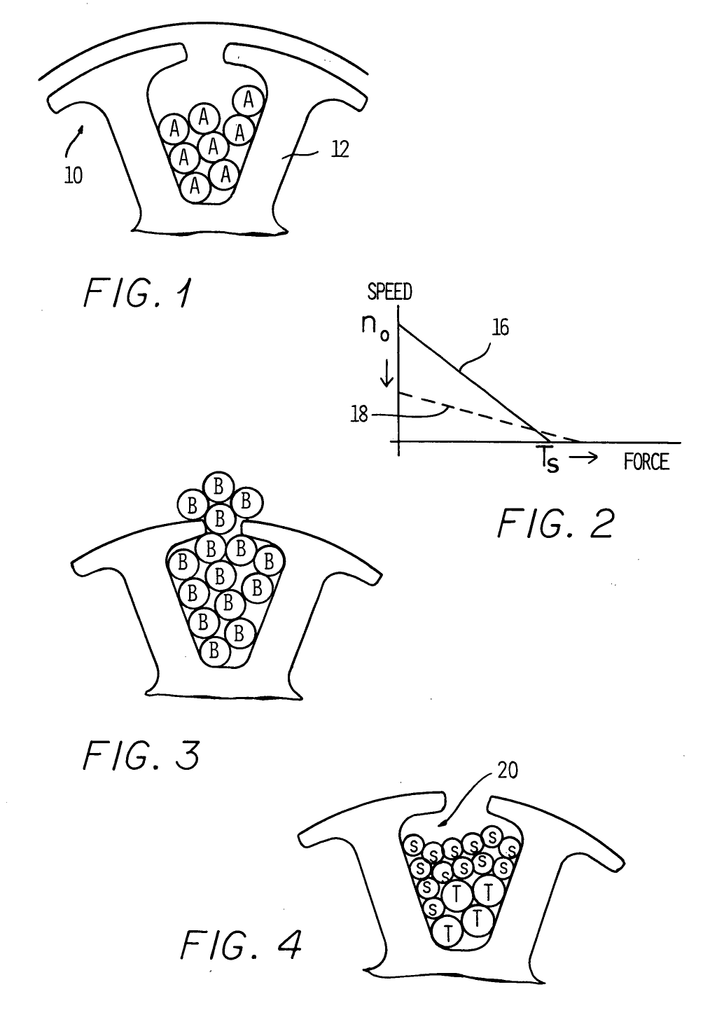

The theoretical performance curve 16 of the motor 10 of FIG. 1 is shown in FIG. 2. Note that the no-load speed is designated no, while the stall torque is designated Tₛ. A new application requires a slower speed and higher force. The performance curve 16 has to shift to curve 18 as shown in FIG. 2. According to calculations known to those skilled in the art, to obtain the new performance, the wire gauge must increase from gauge A to gauge B and the number of turns must increase from eight (8) to 15. Unfortunately, as illustrated in FIG. 3, the new winding is over the slot-fill limit. Traditionally, the only option is to increase the size of the machine. This involves moving to a longer machine, one with a larger diameter, or one both longer and with a larger diameter.

A composite winding can achieve the desired performance without an increase in package size, keeping a machine smaller and less expensive than the alternative. Instead of adjusting turns and changing the gauge of the wire, a composite winding controls the performance of the machine with at least two different windings in the armature. One winding is mainly used to control speed in a motor or voltage in a generator, and the other is manly used to control torque in a motor or current in a generator. Thus, while one bobbin is wound on top of the other, as is sometimes done in so-called double-windings, the bobbins have different turns and wire gauges.

For simplicity, the description that follows is described with reference to a motor. Thus, the winding of the composite winding that is used generally to control speed in a motor and voltage of a generator is called a speed winding, and the winding of the composite winding that is used generally to control torque in a motor and current of a generator is called a torque winding. Consequently, the performance curve of a motor, which reflects torque vs. speed, is described herein. However, the performance curve of a generator, which reflects current vs. voltage, is similar. FIG. 4 illustrates the principles of the invention by showing a slot with a composite winding. The speed winding (S) is preferably wound with the thinnest wire that is feasible from cost and manufacturing considerations. Because of the small cross-sectional area of the wire, this bobbin contributes little to the filling of the slot 20. A large number of turns is not a problem since each turn takes up minimal space in the slot 20. This winding S is used mainly to control speed. Relative to the torque winding, the speed bobbin will have most of the turns in the armature. The torque winding (T) is wound with the wire gauge that yields the desired motor strength with the least number of turns. The number of turns is used to limit current draw but not to control speed. This wire has a greater diameter than that of the speed winding. Since only a few turns will be required, however, the amount of slot filled will be much less than with the traditional approach.

More specifically, the method for selecting the windings is based in part on manufacturing constraints as purely theoretical calculations will result in an impossibly small wire gauge for the speed, or voltage, winding and one turn for the torque, or current, winding. Depending on the available winding equipment, there is a limit to how thin a wire one can wind. Also, in a motor, the number of turns in the torque winding are used to control stall current.

Knowing these factors, one approach to composite windings is developed. First, according to standard methods known in the art, one calculates the winding that will produce the desired performance in the machine. If the winding exceeds slot fill-limits, a composite winding can be considered. To determine the size of the composite winding, one would first define the wire gauges. The speed winding wire gauge is selected as, for example, the smallest cross-sectional area wire that the manufacturer can wind. One small wire that could be used is 23 awg wire, which has a cross-sectional area of 0.258 mm². The torque winding cross-sectional area At is then estimated as follows:
At=(Kt)(A)−As; where
As is the cross-sectional area of the speed winding;
A is the cross-sectional area of a standard winding calculated in accordance with the standard methods for the desired motor variables; and
Kt is a constant greater than one (1) relating the torque winding to the desired, composite stall torque of the motor, which is preferably determined by empirical methods. Where the machine is a generator, the constant Kt is a constant relating the current winding to the desired, composite short circuit current of the generator. By example, Kt is 1.28, and the standard winding calculated in accordance with standard methods is 0.606 mm². Thus,
   At=(1.28)(0.606)−0.258=0.51768 mm².
   This is roughly the cross-sectional area of 20 awg wire.

The second step would be to define the number of turns. This is done by solving two simultaneous equations:
Ts+Tt=(Ks)(T); and
TsAs+TtAt=(Kw)(SA); where
Ts is the speed winding turns;
Tt is the torque winding turns;
T is the winding turns calculated in accordance with the standard methods where A is the cross-sectional area of the winding;
SA is the slot area in the armature;
Kw is a winding constant for slot fill, i.e., a fill factor, determined by manufacturing whose value is around 0.5; and
Ks is a constant relating the speed winding to the desired composite, no-load speed of the motor, which constant is preferably determined by empirical methods. Where the machine is a generator, the constant Ks is a constant relating the voltage winding to the desired, composite open circuit voltage of the generator.

In the example, Kw is 0.5, Ks is 1.71, T is 10 turns and SA is 11.71 mm². Thus, solving for Ts yields:
Ts+Tt=(1.71)(10); and
Ts=17.1−Tt.
Substituting Ts into the second equation yields:
(17.1−Tt)(0.258)+Tt(0.518)=(0.5)(11.71); and]
Tt=5.55 turns or 6 turns.
Thus,
Ts=17.1−Tt=11.55 turns or 12 turns.

The formulas used, and the principles behind them; show that zero-current (no-load) speed is independent of wire gauge and that stall torque is unrelated to the number of turns. Test samples validate these conclusions. Specifically, three sets of three direct-drive motors were built with different sets of windings. One set had a speed winding comprising 12 turns of 23 awg. Another group had a torque winding comprising six (6) turns of 20 awg. The final units had a composite winding comprising 12 turns of 23 awg and six (6) turns of 20 awg calculated according to the method described above.

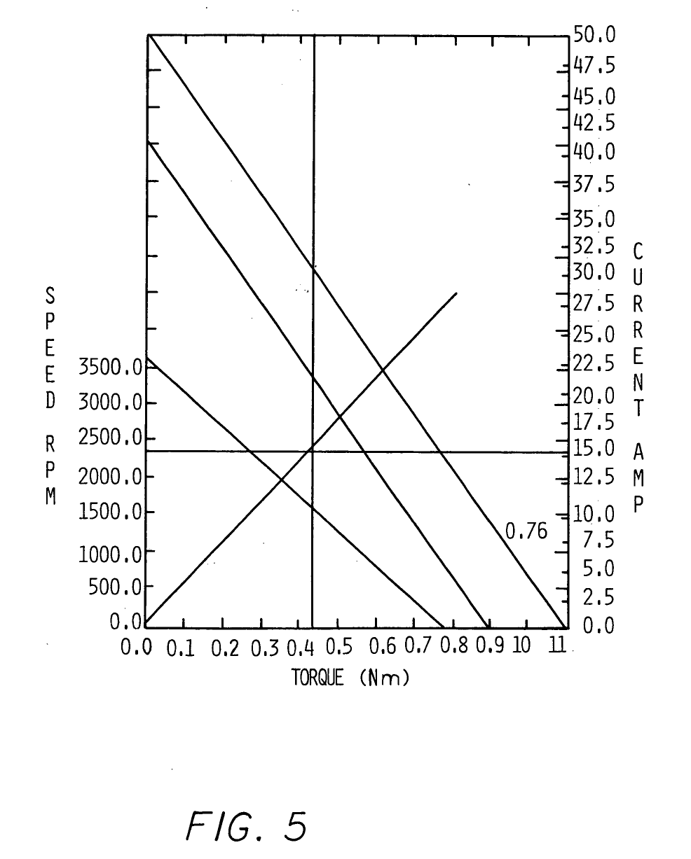

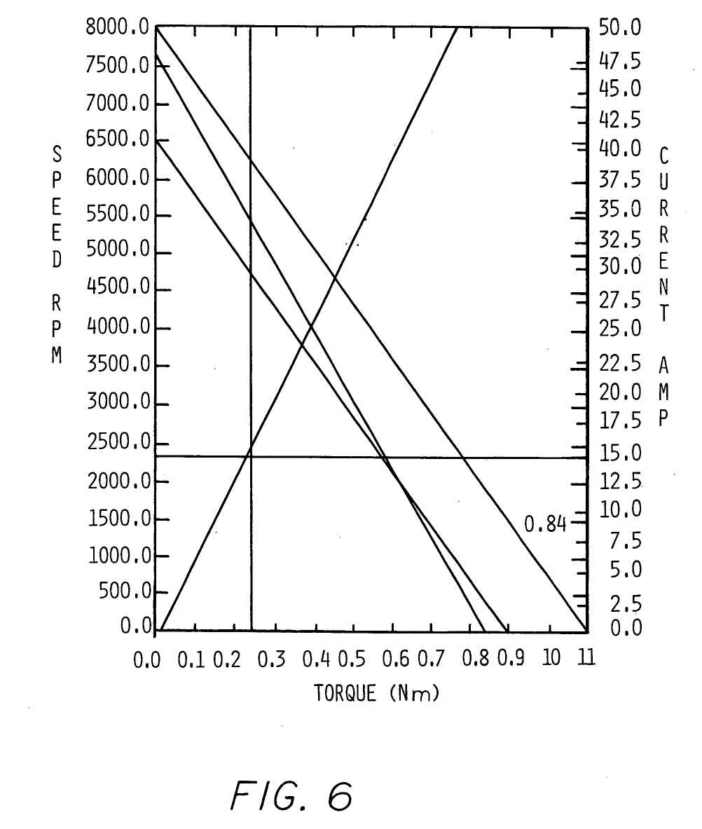

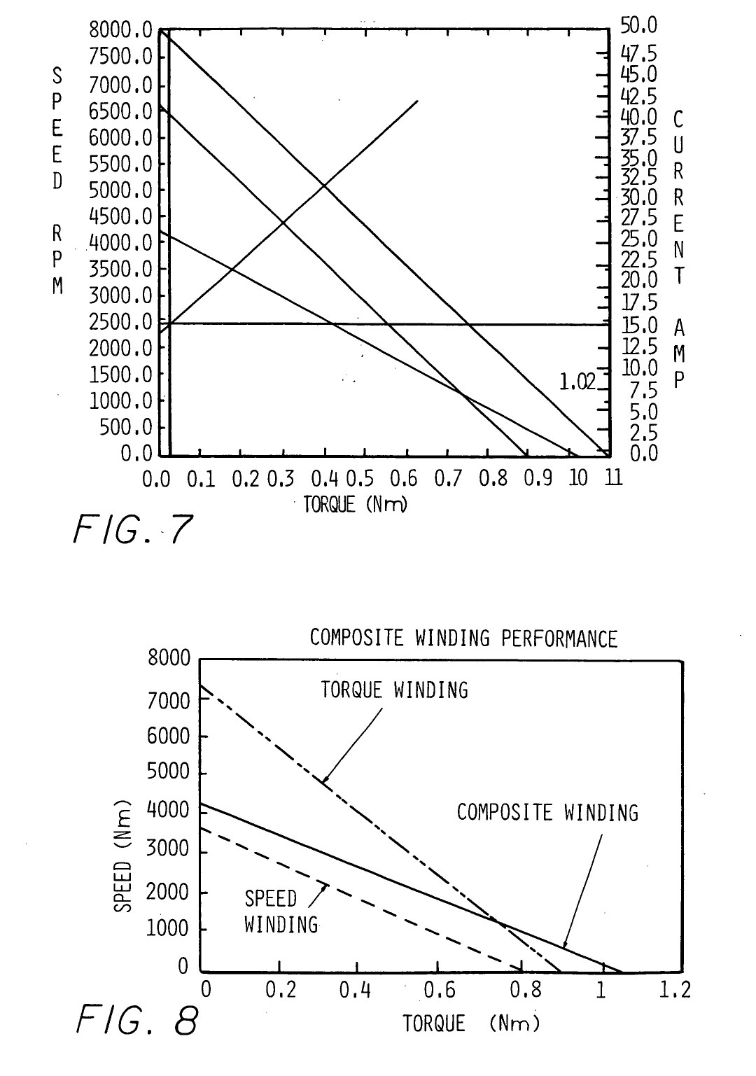

FIGS. 5 and 6 illustrate the typical performances of the speed and torque windings. As shown in FIG. 5, the average free speed of the motor with the speed winding was 3,670 rpm, and the stall torque was 0.77 Nm. As shown in FIG. 6, the average free speed of the motor with the torque winding was 7,300 rpm, and the stall torque was 0.87 Nm. When the windings are combined in one motor, the average free speed becomes 4,200 rpm and the stall torque becomes 1.02 Nm as shown in FIG. 7. Thus, the graphs show one can control the performance of a motor by manipulating these independent windings. To more easily compare performances, FIG. 8 plots the three motor performances in one chart. Note that the voltages between the two sets of windings are different, and consequently current will flow from one coil to another, which is different from conventional motor designs. Results for a generator would be similarly obtained.

Composite windings are useful in at least three design instances. First, they can be used to relieve slot-fill limitations and to increase torque/current, reduce speed/voltage, or both. Second, such windings can reduce the size of the machine package in many designs but in particular in those with low slot fill. Finally, the composite windings can be used to eliminate gear boxes from machines with low reduction ratios (up to 5:1). These applications result in smaller, lower cost machines.

What is claimed is:

1. An energy conversion machine comprising:
an annular stator;
a rotatable rotor facing a surface-of the stator, the rotor including a plurality of rotor slots;
a first winding in at least one of the plurality of rotor slots, the first winding having a first cross-sectional area and a first number of turns; and
a second winding in the at least one of the plurality of rotor slots, the second winding having a second cross-sectional area different from the first cross-sectional area and having a second number of turns.

2. The machine according to claim 1 wherein the first cross-sectional area is smaller than the second cross-sectional area.

3. The machine according to claim 2 wherein the first number of turns is greater than the second number of turns.

4. The machine according to claim 1 wherein the first number of turns is greater than the second number of turns.

5. A method of manufacturing an energy conversion machine including a stator and a rotor, the rotor including rotor slots, the method including the steps of:
installing a first winding in at least one of the rotor slots, the first winding having a first cross-sectional area and a first number of turns; and
installing a second winding in the at least one of the rotor slots, the second winding having a second cross-sectional area different from the first cross-sectional area and having a second number of turns.

6. The method according to claim 5, further comprising the steps of:
selecting the first winding; and
selecting the second winding wherein the second cross-sectional area is smaller than the first cross-sectional area.

7. The method according to claim 6 wherein the second number of turns is greater than the first number of turns.

8. The method according to claim 5 wherein the machine is a motor, the method further comprising the step of:
selecting the first winding using a desired stall torque of the motor.

9. The method according to claim 8, further comprising the step of:
selecting the second winding using a desired no-load speed of the motor.

10. The method according to claim 9 wherein the first cross-sectional area is larger than the second cross-sectional. area.

11. The method according to claim 8 wherein the first cross-sectional area is larger than the second cross-sectional area.

12. The method according to claim 5 wherein the machine is a generator, the method further comprising the step of:
selecting the first winding using a desired short circuit current of the motor.

13. The method according to claim 12, further comprising the step of:
selecting the second winding using a desired open circuit voltage of the motor.

14. The method according to claim 13 wherein the first cross-sectional area is larger than the second cross-sectional area.

15. The method according to claim 12 wherein the first cross-sectional area is larger than the second cross-sectional area.
